(19) United States
(12) Patent Application Publication
(10) Pub. No.: US 2007/0101902 A1
(43) Pub. Date: May 10, 2007

(54) Low VOC solvent useful with paints and coatings

(76) Inventors: Randall M. Frees, Nicholasville, KY (US); Paul Coty, Felton, CA (US); Steven H. Bortz, West Lake Village, CA (US)

Correspondence Address: STOCKWELL & SMEDLEY, PSC, 861 CORPORATE DRIVE, SUITE 200, LEXINGTON, KY, 40503, US

(21) Appl. No.: 11/593,248

(22) Filed: Nov. 6, 2006

Related U.S. Application Data
(60) Provisional application No. 60/733,629, filed on Nov. 4, 2005.

(51) Int. Cl. B41M 5/165; B01F 1/00

(52) U.S. Cl. 106/311; 252/364

(57) ABSTRACT

A paint coating having a reduced amount of Volatile Organic Constituents is disclosed.

### CROSS-REFERENCE TO RELATED APPLICATIONS

This application claims priority to U.S. Provisional Application No. 60/733,629, which was filed on Nov. 4, 2005.

### FIELD OF THE INVENTION

This invention relates to chemicals used in the formulation of paint coatings.

### BACKGROUND OF THE INVENTION

Many solvents contain Volatile Organic Constituents (VOCs). However, in recent years, VOCs have become undesirable due to their effect on the environment. Consequently, a new style of coating that reduces the amount of VOCs is desired.

### SUMMARY OF THE INVENTION

It is an object of the present invention to provide a method of manufacturing a coating having a reduced amount of VOCs. These and other objects and advantages of the invention will become readily apparent as the following description is read in conjunction with the accompanying drawings.

### BRIEF DESCRIPTION OF THE DRAWINGS

FIG. 1 shows an exemplary method of manufacturing the present invention.

### DETAILED DESCRIPTION OF THE PREFERRED EMBODIMENT

Before explaining the disclosed embodiment of the present invention in detail it is to be understood that the invention is not limited in its application to the details of the particular arrangement shown, since the invention is capable of other embodiments. Also, the terminology used herein is for the purpose of description and not of limitation.

Current raw materials available to paint coating manufacturers contain chemicals that do not comply with government air quality standards and regulations, and are extremely hazardous to human beings. However, the present invention is non-hazardous under OSHA regulations, non-flammable, and is classified as an “exempt” solvent for volatile organic compounds (VOCs) by the EPA.

The present invention is a near perfect match for the replacement of toluene and resin bases currently being used in the formulation of paint coatings. The advantages of the present invention are at least the following:
a) effectively replaces chemicals classified as (California) Proposition 65 chemicals and therefore reduce the exposure to cancer causing ingredients,
b) government regulations are forcing the reduction of VOC content in paint coatings, and the present invention reduces the VOC content in paint coatings without sacrificing performance,
c) carries resins to the end result which allows for the formulation of high quality coatings, and
d) as a bio-based and bio-degradable solvent, the present invention enables manufacturers to decrease their dependence on petroleum derivatives.

The formulation of the present invention consists of a combination of soybean methyl esters, dibasic esters, and triethanolamine. The esters used in the present invention work together as both a solvent and a dispersant. The electrochemical bonds of the dibasic esters act as the dissolving agent, breaking up resins and pigments. The soybean methyl esters then quickly bond to the free molecules causing them to be protected and held in suspension. The suspended materials are then integrated with the solids content of the material and dry with all bonds in place. The dibasic ester is a volatile and gases off slowly and does not damage the film. Accordingly, the present invention achieves a blend that both dissolves and breaks bonds in resins and pigments, but also has a second component molecule that then re-binds these materials quickly and securely.

One exemplary formula for manufacturing the present invention uses a soybean methyl ester in the amounts of 20-80% by weight, based on the total weight of the overall formula. The remaining 80-20% of the formulation of the present invention is dibasic esters (DBEs).

The present invention can be formulated from and can incorporate any or all purities and grades of soybean methyl esters. Synonyms and trade names of the soybean methyl ester include methyl palmitate, methyl stearate, methyl oleate, methyl linoleate, and methyl linolenate mixtures. The composition of the methyl ester used in the present invention is a mixture of hexadecanoic acid, octadecanoic acid, 9-octadecenoic acid (Z)-,9,12-Octadecadienoic acid (Z,Z)-, and 9,12,15-Octadecatrienoic acid (9Z, 12Z, 15Z).

The dibasic esters (DBEs) used within the present invention can have many grades, including but not limited to DBE-1 through DBE-9, and DBE-LVP. The present invention can incorporates all grades of dibasic esters. The composition of dibasic esters is a mixture of dimethyl glutarate, dimethyl adipate, and dimethyl succinate, as stated in selected grades.

Because soybean methyl esters can produce leftover fatty acids, triethanolamine is incorporated into the formula as a neutralizer. The inventive formula contains an amount of triethanolamine of 0-5% by weight, based on the total weight of the formula.

The present invention has the following characteristics.
appearance—near water white to very light yellow.
odor—very slight
specific gravity—0.963
flash point—>100° C.
boiling point—>216° C.
exemptions—Exempt LVP Solvent under California consumer products regulations
hazardous ingredients—no known toxic ingredients; no components listed SARA III or under Calf. Prop. 65 list.

A summary of the benefits of the present invention can include, but is not limited to the following:
reduced VOC content and use of hazardous solvents.
improves flow and consistency of finished formulations.
improves penetration and adhesion
maintains color depth and coating gloss/opacity
reduces odors
raises flash points

The present invention can be used within at least the following applications, as well as others:
lacquer and lacquer retarder
lacquer and paint thinner
oil based paint
water based paint
paint gun, equipment, and brush cleaner
stains and sealer
surface deglosser
high solids primer
fingernail polish remover
solvent and waterborne fingernail coating

The present invention can replace other compounds containing any of mineral spirits, xylene, linseed oil, plasticizers, drying oils alkyd resins, and methylethylketone, and acetone. The benefits of the present invention can include but are not limited to good wood penetration, no yellowing (in fact no color transitioning of any kind), low viscosity, low odor, and gives the user some control over the drying time after application. The present invention also easily blends with other exempt solvents. The present invention is also lower in solids content, higher in KB value, dissolves pigments, dissolves nitrocellulose, and is non-flammable. The present invention is also resistant to mold and mildew.

The present invention can be used as a wood treatment, wood stains, a teak oil, concrete stain, waterproofing compound, a sanding sealer. The present invention can also be used with either enamel or a latex paint formulation

The present invention is a non-volatile organic solvent that can be used to replace traditional solvent components in paint and coatings formulations such as MEK, MAK, toluene, benzene, xylene, mineral spirits, D'Limonene, and acetone. When used to replace traditional solvents such as xylene or toluene, the present invention reduces VOC's, sustains color, provides equal or improved gloss, and can increase the solids count of finished coatings. Unlike traditional solvents, the present invention has a resin component that remains behind in the coating, without causing a reduction of the other resins and pigments in the formulation.

The present invention provides a high kB value solvent that improves dispersal of colorants and regulated dry times in today's low VOC lacquers, stains and other coating products. When used with other exempt solvents, such as acetone or methyl acetate, the present invention provides the drying control, reduces order, and improves dispersion and penetration characteristics of the finished coating.

These formulations also benefit from the products basic advantages:
low odor;
increases solid count;
improves flow and consistency of high solids coatings;
high KB Value (dissolves resins and colorants);
safe, non hazardous material; non-flammable in concentrated state;
improves adhesion to many substrates;
increases moisture resistance;
raises flash points of solutions utilizing Acetone or other flammable hydrocarbon solvents;

The present invention can be used as any of the following products.

Oil Based Paint/Primer Component: The present invention is an effective solution for a low-VOC solution in an oil base paint. The present invention can be used to provide the solvency needed to disperse and hold resins and colorants, while not adding any VOC to the blend. This allows for other compounds to be used to regulate drying times and counteract the slower drying time of the present invention. Suggested usage is 5%-15% of total formulation by volume.

Lacquer Retarder: Strong solvency and slow evaporation rates slows the dry time of low VOC lacquers, preventing blushing and allowing for proper brush on times. Slowing drying can prevent unwanted brush marks or unwanted flash drying. Use 2%-5% by volume, depending on desired drying qualities.

Stains and Sealer Component: The present invention provides an excellent solvent base for carrying colorants and silicas often used in stains and sealants. Excellent penetrating capability in wood, concrete and other porous materials. Does not harm or dry wood substrates. Typical quantities used in stain are 5%-25% of the total formula, depending on the drying and penetrating characteristics required.

Pain and Lacquer Thinner Component: High KB values allow small percentages of the present invention to be used to regulate drying times and raise flash points of pain and lacquer thinners. Customer formulations can dramatically reduce the VOC content of thinners. Other LVP and exempt solvents can be blended with the present invention to provide custom low VOC formulations. Can replace or reduce the use of MEK, MAK, Naphtha or mineral spirits. The present invention blends easily with acetone. A typical formulation would be 90% Acetone and 10% of the present invention.

Coating Reducer: Blending a percentage with isoalkyanes will help reduce viscosity and retard the drying time of paints and coatings. Improves flow of coatings.

Brush and Equipment Cleaner: Excellent cleaning power for brushes, spray gun equipment, or paint booth operations. Blend in quantities of 15%-30% with Acetone, or use straight for brush restoration on dried residues. The present invention will help condition brushes and leaves a rust resistant barrier to protect spray gun equipment.

Brush Restorer: The present invention can be used to restore old brushes, clean old dried paint from spray equipment, or to clean off fresh or dried overspray from a variety of surfaces. Brushes can be soaked for an extended period without damaging natural or synthetic bristles. Residue rinse away with water.

Surface Prep-Deglosser-no sand: The present invention combined with other solvents will create an excellent surface prep, deglosser, and no-sand surface preparation product.

Fingernail Coatings: The present invention is a replacement material for both toluene and DBP'S. The material easily dissolves nitrocellulose and other resins and the non-volatile portion of the material provides needed elasticity to the coating. This results in a more durable, less brittle coating that is less likely to chip crack or peel. The material penetrates and binds to the nail providing a protective layer that is gentle and non-damaging to the fingernail. This material is low odor and will help reduce separation of the nail coating in the bottle and improve flow and cohesion, while improving solids counts and coverage. The product may improve the gloss of a surface, depending on the type of paint that was originally used. The material is an excellent choice for base coats as it provides excellent filing and smoothing of the nail.

Waterborne Coatings: The present invention is an excellent choice for water-born coatings. This material helps bring some of the qualities of solvent-born performance to the world of water-based coatings. The present invention will improve dispersion and cohesion of these coatings. The material may also improve adhesion of the coating due to its excellent penetrating qualities. The material can be used in water-based stains, lacquers, latex paints and other coatings.

Nail Polish Removers and Thinners: The present invention is an excellent material for use in nail polish remover or thinner products. The present invention offers custom blended non-hazardous, non-acetone, and non-toxic formulations.

The following government and legislative initiatives are relevant to the present invention.

The California Air Resources Board sets consumer products standards for VOC emissions, and charges companies VOC emission fees for VOC's sold in the state.

The EPA has instituted an Environmentally Preferred Purchasing program, which requires government buyers to utilize environmentally preferred products where available, and favors bio-based and renewable products. This applies to military and other federal purchasing organizations.

The LEED—Leadership Energy and Environmental Design is a national building certification system helps define environmental standards for building design and maintenance.

The present invention has the following attributes:
high clarity, low viscosity solvent for coatings;
high KB value provides superior dissolving power;
excellent dispersant;
supports high solids formulations;
resistant to mold and mildew;
replaces Xylene, Toulene, and MEK; and
wide range of uses including component material within lacquers, paint thinners, top coats, primers, stains and inks.

Additionally, 37 States will implement VOC regulations for consumer products and/or architectural coatings in the near future. Consumer awareness on issues such as indoor air quality, global warming, and carbon reduction is increasing. Green business is growing in virtually every market

Other customer sectors for the present invention might include facilities maintenance and building care. Government and institutional buyers are demanding green products that perform. Consumers are exposed daily to news of global warming, smog warnings, and high petroleum prices, causing them to review the product choices more carefully when it comes time to buy.

The present invention's high solids material provides excellent coating modifier, which can replace plasticizers such as DINP and DBP. The resulting material can have applications in coatings, cosmetics, and wood treatments. Low viscosity material improves coating flow and improves pigments and resin dispersion.

The present invention can be blended with other drying oils, pigments and resins, and is easily blended with Acetone, TBAC and Methyl Acetate to make low VOC coating base blends with unique and controllable drying.

The present invention will improve performance and differentiate the commodity offering of the exempt solvents. Custom solvent base blends will reduce logistical and blending costs for manufacturers. The present invention will also help existing solvent blends produce verifiably superior results in terms of wood protection, aging and mold/mildew resistance.

The dibasic esters used within the present invention are not volatile, they gas off slowly, and do not damage the paint film. The present invention coalesces to the paint film and has a specific effect on it, and in doing so addresses three requirements that the film needs to coalesce correctly:
a) Provides solvency (in combination with DBE) that keeps the solids in a liquid form so they can flow freely. This is a useful feature that make the present invention suitable for replacing any of mineral spirits, toulene, xylene, MEK, butyl acetate, and others. The DBE/Soy combination improves the flow characteristics dramatically, due to the strong solvency of and slow evaporation rates of the Soy/DBE blends;
b) Provides plasticity or flexibility in the coatings. The soy methyl ester acts as a plasticizer, allowing for precise film hardness requirements to be achieved. Replaces controversial or known to be harmful materials such as di-butyl phalate (DBP) or DINP. We replace them with a natural soy resin; and
c) Provides solids that coalesce in the film and act as binders to other materials. The soy molecule is a double bond molecule, which allows it to be a bridge or binder between various other molecules.

The present invention uses a single color grade to insure consistency of the resulting product. This grade is 0 on the gardener scale of color. This means it is water clear or near to water clear. Other oils in this category tend to be a yellow to amber color (4-8 on the gardener scale). Because of this, the present invention provides the highest color transmission rate 97%. The next best performer presents only a 94% color transmission rating. This translates to better color performance of pigments and resins, and results in improved gloss for most coating types. The present invention tests to be “neutral to positive” in gloss testing.

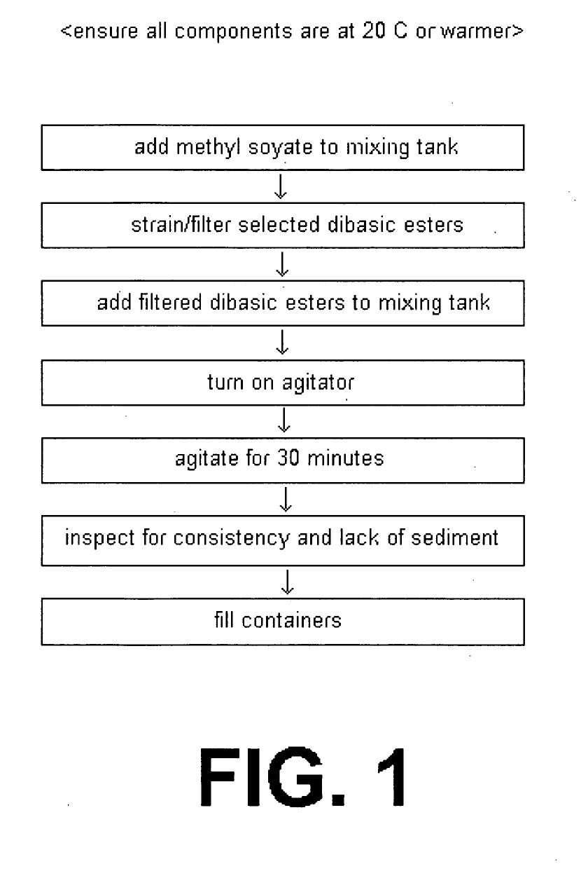

An exemplary embodiment of the present invention can be formulated as follows, as shown in FIG. 1
(all components must be 20° C. or warmer before start of procedure)
add Methyl Soyate to a mixing tank;
strain or filter the particular dibasic ester that will be used;
add the specific desired dibasic ester to the mixing tank;
turn on the agitator under moderate mixing speeds, so that the mixing tank is bottom blended;
continue agitating for 30 minutes after all components are added;
inspect for consistency, clarity, and lack of sediment or particulate; and
fill appropriate containers.

It is anticipated that various other applications for this invention will be discovered without departing from the spirit and scope of the invention, as depicted in the following claims.

What is claimed is:

1. A method of manufacturing a paint coating, comprising:
locating a liquid mixture comprising methyl esters in a mixing container;
adding dibasic esters to the mixing container thereby forming a coating;
agitating the coating;
where the liquid mixture of methyl esters is approximately 20-80% by weight of the coating, and the remainer is dibasic esters.

2. The method of claim 1, further comprising:
the methyl ester being a soybean methyl ester.

3. The method of claim 1, further comprising:
the methyl ester being any of methyl palmitate, methyl stearate, methyl oleate, methyl linoleate, and methyl linolenate mixture.

4. The method of claim 1, further comprising:
the methyl ester being a mixture of hexadecanoic acid, octadecanoic acid, 9-octadecenoic acid (Z)-,9,12-Octadecadienoic acid (Z,Z)-, and 9,12,15-Octadecatrienoic acid (9Z, 12Z, 15Z).
